(19) United States
(12) Patent Application Publication
(10) Pub. No.: US 2023/0342712 A1
(43) Pub. Date: Oct. 26, 2023

(54) SYSTEMS AND METHODS FOR INVENTORY MANAGEMENT

(71) Applicant: Walmart Apollo, LLC, Bentonville, AR (US)

(72) Inventors: Luke Johnson, Springdale, AR (US); Ashok Ramaraj, Frisco, TX (US); Naveen Veloorkumara, Irving, TX (US); Chandan Sharma, Castro Valley, CA (US); Imelda Garcia, Gilroy, CA (US); David G. Bradley, Bentonville, AR (US); Todd S. Garner, Austin, TX (US); Kamil Bay, Rogers, AR (US)

(21) Appl. No.: 17/798,012

(22) PCT Filed: Feb. 5, 2021
(86) PCT No.: PCT/US2021/016844

§ 371 Date: Aug. 5, 2022

Related U.S. Application Data
(60) Provisional application No. 62/970,389, filed on Feb. 5, 2020.

(51) Int. Cl. G06Q 10/087; G06Q 10/0631

(52) U.S. Cl. CPC G06Q 10/087; G06Q 10/063114; H04L 63/0815

(57) ABSTRACT

In some embodiments, apparatuses and methods are provided herein useful to inventory management systems for retailers. In some embodiments, an inventory management system comprises a control circuit, wherein the control circuit is communicatively coupled to a networked server system and configured to receive, from in-store systems, inventory management information, generate, based on the inventory management information, inventory management tasks, transmit, to the networked server system, the inventory management tasks to be maintained by the networked server system, receive, from a mobile device, user credentials, and authenticate, based on the user credentials, the mobile device, and an application configured to be executed on the mobile device and wherein the application when executed on the mobile device is configured to receive, from the mobile device, the user credentials, cause transmission of the user credentials, access the networked server system, and cause presentation, via a display device, indications of the inventory management tasks.

### CROSS-REFERENCE TO RELATED APPLICATION

This application claims the benefit of U.S. Provisional Application No. 62/970,389, filed Feb. 5, 2020, which is incorporated by reference in its entirety herein.

### TECHNICAL FIELD

This invention relates generally to inventory management and, more particularly, devices used for inventory management.

### BACKGROUND

Ensuring that products offered for sale are available to customers and properly located on a salesfloor is important to retailers for many reasons. From a customer's perspective, he or she may become frustrated and/or dissatisfied if he or she cannot find, or had difficulty locating, the products he or she wishes to purchase. Obviously, retailers do not want their customers to be frustrated and/or dissatisfied. Further, from a retailer's perspective, if products are not on the sales floor or improperly located on the salesfloor, it can result in lost sales. Modern retailers employ complex inventory management systems in an effort to keep their salesfloors properly stocked. However, current systems have many drawbacks. For example, many of these systems incorporate handheld devices capable of presenting inventory information to employees. The employees can then act on the provided information. Unfortunately, these handheld devices are company-owned (e.g., owned by the retailer). Employees are often unfamiliar with such devices and have trouble using them. Additionally, it is burdensome to keep track of such devices, ensure they are properly charged, and ensure they are properly located so that employees can use them during their work hours. Further, the functionality of these devices is often limited for example, based on hardware and/or cost constraints. Accordingly, a need exists for better systems, apparatuses, and methods for inventory management.

### BRIEF DESCRIPTION OF THE DRAWINGS

Disclosed herein are embodiments of systems, apparatuses, and methods pertaining to an inventory management system for a retailer. This description includes drawings, wherein:

FIG. 1 depicts a mobile device 102 executing an inventory management application, according to some embodiments;

FIG. 2 is a block diagram of a system 200 for inventory management, according to some embodiments;

FIG. 3 is a flow chart depicting example operations of an inventory management system, according to some embodiments; and

FIG. 4 depicts a mobile device 402 executing an inventory management application with an alternate user interface 404, according to some embodiments; and

FIG. 5 is a block diagram of a mobile device 500, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to inventory management for a retailer. In some embodiments, an inventory management system for a retailer comprises a networked server system comprising a plurality of computer hardware components and memory structures, the networked server system configured to function as a public cloud and maintain inventory management tasks, a control circuit, wherein the control circuit is communicatively coupled to the networked server system, and wherein the control circuit is owned and operated by the retailer independently of the public cloud owned and operated by a third party, the control circuit configured to receive, from a plurality of in-store systems, inventory management information, wherein each of the plurality of in-store systems is associated with a different retail facility of the retailer, generate, based on the inventory management information, the inventory management tasks, transmit, to the networked server system, the inventory management tasks, receive, from a mobile device, user credentials, and authenticate, based on the user credentials, the mobile device, wherein the authentication allows the mobile device to access the networked server system, and the mobile device, wherein the mobile device is maintained by an employee of the retailer, wherein the mobile device is communicatively coupled to the networked server system, and wherein the mobile device is configured to receive, at the mobile device, the user credentials, transmit, to the control circuit, the user credentials, access the networked server system, and present, via a display device, indications of the inventory management tasks.

As previously discussed, inventory management is important to retailers. Ensuring that product display units are properly stocked not only promotes customer satisfaction but can also increase sales for the retailer. Additionally, accurate tracking of inventory provides significant data to the retailer. For example, if a retailer knows how many instances of a product are on the salesfloor and/or in the stockroom, as well as average sales rates for the product, it can aid the retailer in placing order for additional stock. While all of this data is useful to retailers, it is difficult to sort through the data and determine what tasks need to be performed. Further, current inventory management systems utilize company-owned handheld devices. Employees are often unfamiliar with such devices and have trouble using them. Additionally, it is burdensome to keep track of such devices, ensure they are properly charged, and ensure they are properly located so that employees can use them during their work hours. Further, the functionality of these devices is often limited for example, based on hardware and/or cost constraints.

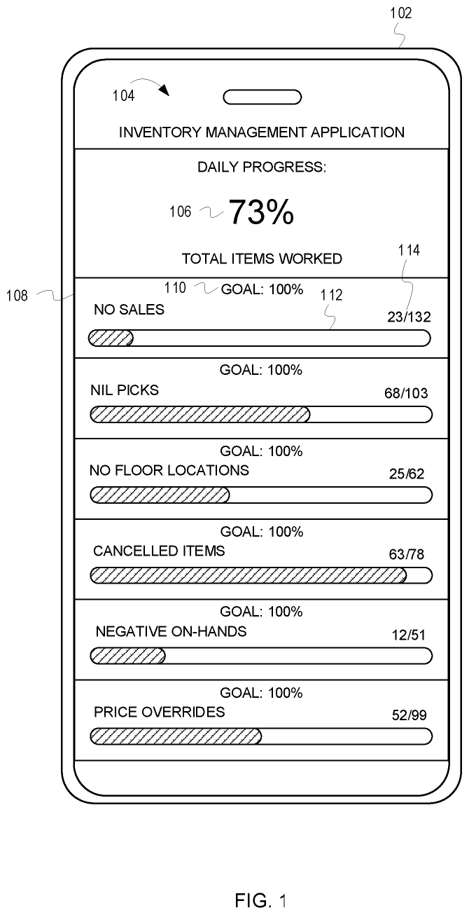

Described herein are systems, methods, and apparatuses for inventory management that aid retailers by providing inventory management tasks to employees. In some embodiments, employees can access inventory management information via their mobile devices (i.e., mobile devices that are maintained by the employees). Employee-owned devices are ubiquitous in the workplace and employee are typically familiar with the operation of their own devices. Further, many people upgrade their devices regularly, increasing the likelihood that a given employee has the latest hardware and/or software. As described herein, employees can bring their own devices to work and use their own devices in the course of their employment to aid the retailer in inventory management. For example, the mobile device can present a list of inventory management tasks to the employee so that the employee can track which tasks have been completed and still need to be completed. The discussion of FIG. 1 provides an overview of such a system.

FIG. 1 depicts a mobile device 102 executing an inventory management application, according to some embodiments. While the mobile device 102 in FIG. 1 is depicted as a smartphone, any suitable type of mobile device can be used. For example, the mobile device 102 can be a tablet computer, personal digital assistant (PDA), smartwatch, laptop computer, media player, etc. The inventory management application can be specific to inventory management tasks or be a general purpose application used by a retailer that includes inventory management functionality. Additionally, though the discussion herein refers to the use of an application, the application need not be an application dedicated to inventory management tasks. For example, the mobile device 102 can be used to access inventory management tasks and/or information via a general purpose application, such as part of an operating system of the mobile device or a web browser executed by the mobile device. In either case, the mobile device 102 presents inventory management tasks for use by an employee.

The mobile device 102 is presenting a user interface 104 associated with the inventory management application. The user interface 104 includes a number of inventory management task fields 108. Each of the inventory management task fields 108 is associated with a different inventory management task (discussed in more detail below). Each of the inventory management task fields 108 includes information regarding an associated inventory management task. For example, the inventory management task fields 108 can include an indication of the inventory management task, a goal 110, a visual progress indicator 112 (e.g., a visual indication of a portion of the inventory management tasks associated with that field which have been completed), and a progress indicator 114 (e.g., a numerical representation of the number of tasks associated with that field which have been completed).

As inventory management tasks are completed, the employee logs completion of the inventory management tasks. The manner in which completion of inventory management tasks are logged can be dependent upon the inventory management task completed. For example, an employee can indicate that an inventory management task has been completed by checking a box associated with, or otherwise selecting, an inventory management task. Additionally, or alternatively, an employee can indicate that an inventory management task has been completed by providing additional and/or different input. For example, if an inventory management task requires an employee to determine whether a product is in-stock (e.g., on the salesfloor or in the stockroom), the employee can indicate that the inventory management task has been completed by capturing an image of the product and/or a product identifier of the product (e.g., via an image capture device of the mobile device). In some embodiments, the indication that the inventory management task has been completed includes an indication of the employee that completed the task. In such embodiments, the employee can positively include this indication and/or the indication of the employee can be included and/or determined automatically, for example, based on an identifier of the mobile device 102 and/or user credentials (discussed in more detail below).

In some embodiments, the inventory management task fields 108 are specific to an employee. For example, the mobile device 102 can present inventory management tasks that are associated with, or have otherwise been assigned to, a specific employee. Additionally, or alternatively, the inventory management task fields 108 can include data for inventory management tasks for a group of employees (e.g., a department, retail facility, or other grouping). The user interface 104 also includes an overall progress indicator 106. The overall progress indicator 106 can be representative of any statistic desired, such as for example, a total percentage of inventory management tasks completed for an employee, a total percentage of inventory management tasks completed by a group of employees, a number of inventory management tasks that are yet to be completed, etc. In some embodiments, the fields and/or information depicted in each of the fields can be adjusted based, for example, on user preferences. For example, a user (e.g., an employee, manager, retailer, etc.) can customize what fields are presented in the user interface 104, the data included in each field, the order and/or placement of the fields, etc.

The inventory management tasks can be any tasks desired and, for example as depicted in FIG. 1, include no sales, nil picks, no floor locations, cancelled items, negative on hands, and price overrides. A few possible inventory management tasks are described in detail below. Though a number of inventory management tasks are described below, it is understood that this is not an exhaustive, or required, list of inventory management tasks and that any desired inventory management tasks can be utilized by the systems, methods, and apparatuses disclosed herein.

No Sales Tasks

A no sales task indicates when no sales, or fewer sales than expected, have occurred for a product. For example, if the inventory management information indicates that a product is in stock, but no sales of the product have occurred for a period of time, a no sales inventory management task can be triggered and/or generated for that product. In some embodiments, the determination that a product should be included in the no sales list is based on a machine learning algorithm. For example, sales histories for products can be logged (e.g., over a period of time). The machine learning algorithm can use this data to estimate a number of expected sales for a product. If the number of sales for the product are lower than the expected sales for the product (e.g., based on a time period, a day of the week, an occurrence of an event, etc.), the product can be added to the no sales list. In response to a no sales task, an employee can perform and investigatory action. For example, the employee can perform an investigatory action to determine if the product is indeed in stock, if the price of the product is too high, if the product is incorrectly located, etc. Once completed, the employee can mark the inventory management task (e.g., a no sales task) for the product as complete via the application. For example, the employee can simply make a selection indicating that he or she completed the investigatory action, capture an image (e.g., of the product or the location for the product) via the mobile device 102, enter a quantity of the product remaining (if any), place an order for the product, indicate a location of the product (e.g., a location in the stockroom or on the salesfloor), etc.

Nil Pick Tasks

A nil picks task indicates that a product that was intended to be included in an order (e.g., an online or phone order, in-store pick up order, etc.) was not picked. For example, a first employee may have been tasked with picking products to fulfill an order. If the first employee did not pick one of the products (e.g., could not find the product or otherwise did not pick the product), a nil pick task for the product can be included in the application. A second employee (or the same employee at a later point) utilizing the application can perform an action in response to the nil pick task. For example, the second employee can attempt to locate the item and/or determine if the item is out-of-stock. The second employee indicates that the nil pick task has been completed by, for example, marking the task as completed, placing an order for the product, capturing a picture associated with the product, updating a location for the product, etc.

No Floor Location Tasks

A no floor location task occurs when a product is in inventory (e.g., in stock) but does not have a location on the salesfloor. As one example, when a new product is received by the retailer, the retailer may not have a location planned and/or designated for the product. The no floor location task instructs the employee to find a location for the product, create a location for the product on the salesfloor, and/or move a product from the stockroom to a location on the salesfloor. The employee can indicate completion of a no floor location task by marking the task as completed, entering a location for the product via the mobile device 102, capturing an image of the location and/or product at the location, creating and/or printing signage for the product, etc.

Cancelled Items Tasks

A cancelled item task occurs when a cancelled item appears in the inventory system. In one embodiment, a cancelled item is an item that will not be replenished (e.g., no additional orders for the item will be placed). As one example, a retailer may choose not to order additional units of a holiday item after the holiday has passed. Though an item has been cancelled, instances of the item may remain in inventory (e.g., unsold holiday items in the example above). The cancelled item task instructs an employee to take an action with regard to the cancelled item. For example, the employee can reduce the price of the cancelled item in an attempt to encourage sales of the item, create new signage for the cancelled item, move the cancelled item to a more prominent or featured location on the salesfloor, etc. The employee can indicate completion of the cancelled item task by marking the task as completed, entering a new price for the item, entering a new location for the item, creating new signage, capturing images of a new location for the item, etc.

Negative On-Hand Tasks

The negative on-hands task occurs when the inventory management information indicates that the retailer currently stocks fewer than zero instances of a product. This can happen for a variety of reasons. As one example, a larger number of a product may be received than listed on a shipping invoice. For example, a retailer may receive 30 instances of an item, though the invoice lists only 20 instances of the item as delivered. If the retailer has sold 25 instances of the item, it may appear that the retailer has fewer than zero instances of that item in stock. As another example, a discrepancy between multiple inventory systems may causes the occurrence of a negative on-hand. An employee can perform a number of actions in response to a negative on-hands task. For example, the employee can reset the inventory to zero, manually inventory the items and/or update the inventory manually, reset the inventory in an effort to synchronize multiple inventory systems, etc. The employee can indicate that the task has been completed by, for example, marking the task as completed, adjusting the inventory level of the item, capturing an image of the items in inventory, etc.

Price Override Tasks

A price override task occurs when an employee performs a price override for a product. For example, when a customer brings a product to a point-of-sale (POS) terminal, the price that registers for the product may differ from that presented on the salesfloor. Typically, if the price presented on the salesfloor is lower than the price that registers at the POS terminal, the retailer will honor the lower price (e.g., by overriding the price that registers at the POS terminal). When a price discrepancy is encountered for a product and/or when an employee overrides a price, a price override task can be generated. An employee can complete the price override task in a number of ways. As one example, the employee can investigate the discrepancy to determine the correct price for the object. If the employee determines that signage on the salesfloor incorrectly states the price for the product, the employee can remove the incorrect signage, as well as create, print, and/or place new signage on the salesfloor. If the discrepancy appears to be with the POS system, the employee can log the discrepancy and what he or she believes the be the correct price via the mobile device 102. In either case, the employee indicates that the price override task has been completed. This indication can include marking the task as completed, capturing pictures, requesting updated pricing, etc. Additionally, in some embodiments, price override tasks may require approval by a managing entity. In such embodiments, for example, the employee can request that new signage be generated and/or printed for the product and the request, once approved by, for example, a manager, is generated and/or printed.

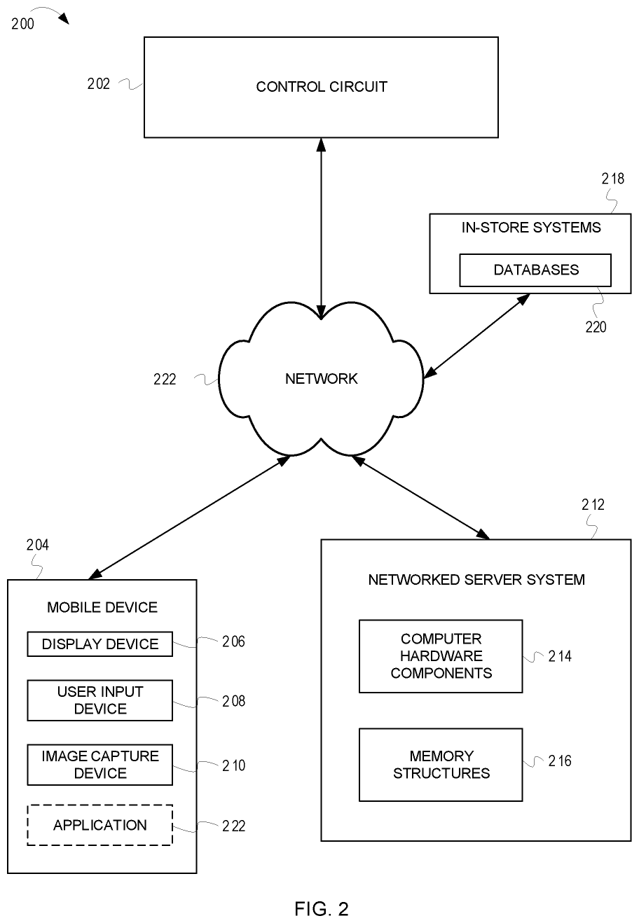

While the discussion of FIG. 1 provides an overview of inventory management tasks and the presentation of inventory management tasks via a mobile device, the discussion of FIG. 2 provides additional detail regarding an inventory management system for a retailer.

FIG. 2 is a block diagram of a system 200 for inventory management, according to some embodiments. The system 200 includes a control circuit 202, a mobile device 204, a networked server system 212, and in-store systems 218. At least some of the control circuit 202, mobile device 204, networked server system 212, and in-store systems 218 are communicatively coupled via a network 222. Accordingly, the network 222 can be of any suitable type. For example, the network 222 can include a local area network (LAN) and/or wide area network (WAN), such as the Internet, and includes wired and/or wireless links.

The networked server system 212 includes computer hardware components 214 (e.g., servers, processors, networking radios, etc.) and memory structures 216. The networked server system 212 is configured to function as a public cloud. For example, the public cloud can host data storage and/or processing and be controlled or hosted by an entity other than the retailer (e.g., a third party). Accordingly, in some embodiments, the networked server system 212 is accessible over a public network, such as the Internet. The networked server system 212 is configured (e.g., by the retailer, inventor management entity of the retailer, etc.) to maintain (e.g., store, host, etc.) inventory management tasks. Additionally, the networked server system 212 can be configured to maintain statuses associated with the inventory management tasks. For example, the statuses associated with the inventory management tasks can include an indication that an inventory management tasks need to be performed, inventory management tasks that are yet to be performed, etc. In some embodiments, the networked server system is also configured to maintain inventory management information, such as inventory data, POS data (e.g., sales data, transaction histories, pricing information, purchase logs, customer data, etc.), shipment information, floor layout information (e.g., planograms), temporal information (e.g., dates associated with products and/or shipments of products), replenishment data, etc. In some embodiments, the configuration of the various data on the networked server system is provided by the retailer and/or entities of, or associated with, the retailer.

The in-store systems 218 gather and/or store inventory management information (e.g., inventory data, POS data (e.g., sales data, transaction histories, pricing information, purchase logs, customer data, etc.), shipment information, floor layout information (e.g., planograms), temporal information (e.g., dates associated with products and/or shipments of products), replenishment data, etc.). Accordingly, the in-store systems 218 can include any suitable systems and databases 220, such as inventory databases, location databases, transaction databases (e.g., including POS systems), etc. Though referred to as “in-store,” the in-store systems need not physically be located in a store (e.g., a retail facility), though they can be. Rather, the in-store systems 218 are “in-store” in that the in-store systems 218 are associated with a retail facility. For example, a first system of the in-store systems 218 may be configured to gather and/or store inventory management information associated with Store₁ of Retailer X. Further, in some embodiments, each of the in-store systems 218, or sets of the in-store systems 218, may be associated with different retail facilities. Continuing the example above, a second system, or set of systems, of the in-store systems 218 may be configured to gather and/or store inventory management information associated with Store₂ of Retailer X.

The control circuit 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 202 is configured (for example, by using corresponding programming as will be well understood by those skilled in the art) to carry out one or more of the steps, actions, and/or functions described herein.

By one optional approach the control circuit 202 operably couples to a memory. The memory may be integral to the control circuit 202 or can be physically discrete (in whole or in part) from the control circuit 202 as desired. This memory can also be local with respect to the control circuit 202 (where, for example, both share a common circuit board, chassis, power supply, and/or housing) or can be partially or wholly remote with respect to the control circuit 202 (where, for example, the memory is physically located in another facility, metropolitan area, or even country as compared to the control circuit 202).

This memory can serve, for example, to non-transitorily store the computer instructions that, when executed by the control circuit 202, cause the control circuit 202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

In some embodiments, the control circuit 202 is part of a server or server system of the retailer. For example, the server comprising the control circuit 202 may be a non-public system of the retailer that communicates variously via the network 222 with the in-store systems 218, the networked server system 212 and mobile devices such as the illustrated mobile device 204. The server or server system may be at one or more locations and may be at or remote from any store of the retailer.

The control circuit 202 is generally configured to generate inventory management tasks. The control circuit generates the inventory management tasks based on inventory management information received from, for example, the in-store systems 218. The control circuit 202 generates the inventory management tasks by assessing the inventory management information and determining that an action needs to be performed. For example, as previously discussed, the control circuit 202 can generate inventory management tasks, such as no sales, nil picks, no floor locations, cancelled items, negative on-hands, price overrides, etc. In some embodiments, the control circuit 202 can employ machine learning algorithms to generate inventory management tasks. By one approach, the control circuit 202 may use a neural network model and, in cooperation with the networked server system 212 and in-store systems 218, generate inventory management tasks. In some implementations, the neural network model may be based, at least in part, on a training neural network (e.g., deep neural network, lightweight neural network, a lightweight convolutional neural network, a lightweight MobileNet, GoogleNet, visual Geometry Group, etc.) using the inventory management information. For example, the control circuit 202 may receive the inventory management information from the in-store systems and generate inventory management tasks based on the inventory management information. Further, in some embodiments, the control circuit can adapt, improve, retrain, etc. the machine learning model over time based on feedback received from the networked server system 212, the in-store systems 218, and/or users. In some embodiments, the control circuit 202 considers a number of features with the machine learning algorithm. For example, the machine learning algorithm can take into account potential sales counts, sales counts since last sold date, average sold units, average sales intervals, etc. The control circuit 202 can use these features, along with the machine learning algorithm, to rank tasks. For example, the control circuit 202 can rank the tasks based on the importance of the task, or any other priority metric.

In addition to generating the inventory management tasks, the control circuit 202 also authenticates users that are trying to access the networked server system 212. Because the networked server system 212 functions as a public cloud, in some embodiments, the system 200 may require users (i.e., users and/or user devices) to be authenticated before they are able to access the networked server system 212 and/or data maintained by the networked server system 212. In such embodiments, the control circuit 202 authenticates the users. As one example, the control circuit 202 can authenticate a user based on user credentials provided by the mobile device 204. The user credentials can, for example, include usernames, user IDs, passwords, passcodes, captcha responses, security prompt responses, two-factor authentication values, etc. In such embodiments, the control circuit receives the user credentials from the mobile device 204 and validates the user credentials, for example, via a backend server or database. In one embodiment, the user credentials are based on a single sign on system. Additionally, or alternatively, the control circuit 202 can authenticate users based on his or her device (e.g., the mobile device 204). For example, the control circuit 202 can authenticate the mobile device 204 based on an identifier of the mobile device 204 (e.g., a media access control (MAC) address, internet protocol (IP) address, phone number, etc.) associated with the mobile device, the network over which the mobile device 204 is attempting to access the networked server system 212, metadata associated with the mobile device, etc. Such data used by the control circuit 202 to authenticate the mobile device 204 is generally referred to as “user credentials,” as used herein.

The mobile device 204 is, generally speaking, the user device that allows an employee to interact with the networked server system 212. For example, the mobile device 204 allows the employee to browse the inventory management tasks and mark inventory management tasks as completed. As previously discussed, the mobile device 204 is maintained by an employee of the retailer. For example, the employee can maintain the mobile device 204 in that he or she owns the mobile device 204, rents the mobile device 204, or is otherwise in control of the mobile device 204. In some embodiments, the employee maintains the mobile device in that he or she brings the mobile device 204 with him or her as part of a bring your own device (“BYOD”) program.

The mobile device 204 can be any type of device suitable for use by an employee with the inventory management system as described herein. For example, the mobile device 204 can be a smartphone, tablet computer, personal digital assistant (PDA), smartwatch, laptop computer, media player, etc. The mobile device 204 depicted in FIG. 2 includes a display device 206, a user input device 208, and an image capture device 210. Though the mobile device 204 depicted in FIG. 2 includes a display device 206, a user input device 208, and an image capture device 210, such is not required. For example, in some embodiments, the mobile device 204 may include greater, or fewer, components that those included in FIG. 2.

The display device 206 generally presents content to the user of the mobile device (e.g., the employee). In the case of an inventory management application, the display device 206 presents user interfaces, graphics, content, etc. associated with the inventory management application to the user. Accordingly, the display device 206 can be of any suitable type (e.g., a light emitting diode (LED) display device, a liquid crystal display (LCD) device, etc.).

The user input device 208 allows the user to interact with the mobile device 204. For example, in the case of an inventory management application, the user input device 208 allows the user to interact with the inventory management application and, via the inventory management application, the networked server system 212. For example, the user input device 208 allows the user to navigate menus, select fields, provide indications of the completion of inventory management tasks, etc. in the inventory management application. Accordingly, the user input device 208 can be of any suitable type. For example, the user input device 208 can include a mouse, keyboard, trackpad, microphone, buttons, etc. Additionally, in some embodiments, the display device 206 and the user input device 208 may be integrated into a single device, such as a touchscreen.

The image capture device 210 allows the mobile device to capture images (e.g., still images, video images, etc., whether permanent or temporary). For example, the user can capture images of product identifiers (e.g., scan product identifiers) via the image capture device 210. The mobile device 204 can use the captured image to retrieve product information from the networked server system 212. For example, the product information can include cost information for the product, inventory information for the product, location information for the product, etc. As another example, the user can capture images of product display units, products, signage, etc. to indicate completion of inventory management tasks, provide data associated with inventory management tasks, etc.

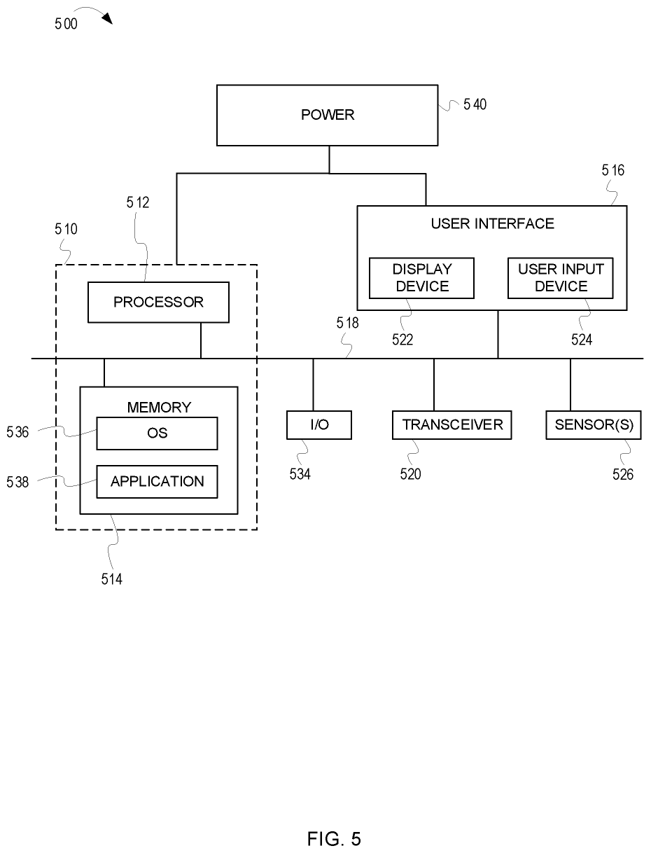

In some embodiments, the mobile device 204 includes an application 222. The application 222 comprises computer program code that is configured to be installed on and executed by the mobile device (e.g., by a processor of the mobile device 204, described in more detail with respect to FIG. 5). The application 222 can be executed by the mobile device 222 in concert with other software modules or applications (computer program code), or groups of applications, such as operating systems, locationing applications (e.g., a mapping, GPS, etc. applications), two-factor authentication (TFA) applications, single sign on (SSO) applications, graphics processing applications, security applications, etc. In one embodiment, the application 222 is the inventory management application, as described herein. In such embodiments, the application can be a dedicated application (e.g., an application specific to a retailer or to inventory management tasks) or a general application that while not a “dedicated application” can perform the functions as described herein with respect to the inventory management application. In some embodiments, the application 222 is an add-on application installed on the mobile device 204 and that cooperates with other application/s of the mobile device 204, such as the operating system and works with the other application/s to provide the functionality described herein. For example, in the embodiment illustrated in FIG. 2 the add-on application communicates with the operating system application of the mobile device 204 to control and receive data from at least the display device 206, the user input device 208 and the image capture device 210. In some embodiments, the application 222 is integral with other applications of the mobile device such as the operating system. For example, in the embodiment illustrated in FIG. 2, the integral application controls and receives data from at least the display device 206, the user input device 208 and the image capture device 210.

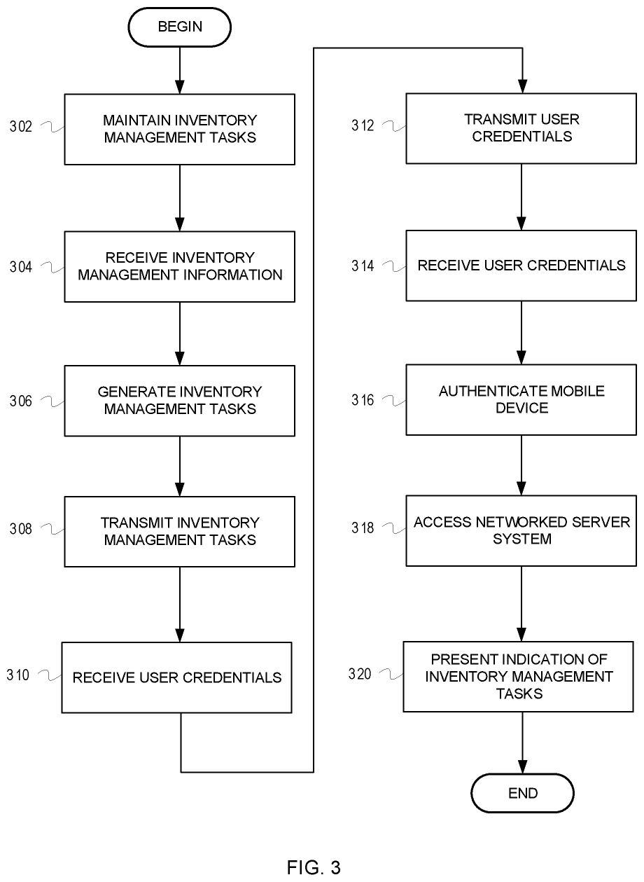

While the discussion of FIG. 2 provides additional detail regarding a system for inventory management, the discussion of FIG. 3 describes example operations of such a system.

FIG. 3 is a flow chart depicting example operations of an inventory management system, according to some embodiments. The flow begins are block 302.

At block 302, inventory management tasks are maintained. For example, a networked server system can maintain the inventory management tasks. In one embodiment, the networked server system functions as a public cloud. In such embodiments, the networked server system may be accessible over a public network, such as the Internet. In addition to the inventory management tasks, in some embodiments, the networked server system maintains statuses for inventory management tasks and/or inventory management information. The flow continues at block 304.

At block 304, inventory management information is received. For example, a control circuit can receive the inventory management information. The inventory management information can include any information relevant to the generation of inventory management tasks. For example, the inventory management information can include stock levels for products, shipment and/or delivery schedules, anticipated stock levels, historic sales figures, temporal information associated with products (e.g., sell-by dates, seasonality, etc.), estimated sales volumes, promotional information for products, location information, etc. In one embodiment, the control circuit receives the inventory management information from a plurality of in-store systems. The in-store systems can include a number of databases, such as inventory databases, location databases, transaction databases, etc. The flow continues at block 306.

At block 306, inventory management tasks are generated. For example, the control circuit can generate the inventory management tasks. The inventory management tasks are tasks that need to be, or have previously been, completed by, for example, employees of a retailer. The inventory management tasks can be any suitable task such as, for example, no sales, nil picks, no floor locations, cancelled items, negative on-hands, price overrides, etc. The control circuit generates the inventory management tasks based on the inventory management information. In some embodiments, the control circuit employs machine learning algorithms to generate the inventory management tasks. The flow continues at block 308.

At block 308, the inventory management tasks are transmitted. For example, the control circuit can transmit the inventory management tasks to the networked server system. Additionally, in some embodiments, the control circuit transmits the inventory management information to the networked server system. The flow continues at block 310.

At block 310, user credentials are received. For example, a mobile device can receive the user credentials from a user (e.g., an employee) via a user input device of the mobile device. In one embodiment, the user credentials are received by an application executing on the mobile device (e.g., via a user input device of the mobile device). The user credentials can, for example, include usernames, user IDs, passwords, passcodes, captcha responses, security prompt responses, two-factor authentication values, an identifier of the mobile device (e.g., a media access control (MAC) address, internet protocol (IP) address, phone number, etc.) associated with the mobile device, the network over which the mobile device is attempting to access the networked server system, metadata associated with the mobile device, etc. The mobile device can receive the user credentials via the user input device by entering the user credentials via the user input device (e.g., entering a username and/or password) and/or by indicating via the user input device that he or she wishes such user credentials to be received and/or transmitted (e.g., selecting a “sign in” button to receive and/or transmit a MAC address associated with the mobile device). The flow continues at block 312.

At block 312, the user credentials are transmitted. For example, the mobile device can transmit the user credentials to the control circuit. In one embodiment, the application executing on the mobile device causes transmission of the user credentials to the control circuit. The flow continues at block 314.

At block 314, the user credentials are received. For example, the control circuit can receive the user credentials from the mobile device. The flow continues at block 316.

At block 316, the mobile device is authenticated. For example, the control circuit can authenticate the mobile device based on the user credentials. Authentication of the mobile device allows the mobile device to access the networked server system. The flow continues at block 318.

At block 318, the networked server system is accessed. For example, the mobile device can access the networked server system. In one embodiment, the application executing on the mobile device accesses, or causes the mobile device to access, the networked server system. The mobile device accesses the networked server system to obtain the inventory management tasks. Additionally, in some embodiments, the mobile device can access the inventory management tasks to provide indications that inventory management tasks have been completed, provide indications of employees that have completed inventory management tasks, retrieve inventory management information, provide images to the networked server system, make requests via the networked server system, etc. The flow continues at block 320.

At block 320, an indication of inventory management tasks is presented. For example, the mobile device, via a display device, can present indications of the inventory management tasks. In one embodiment, the application executing on the mobile device causes the display device to present the indication of the inventory management tasks (i.e., causes presentation of the inventory management tasks). In one form, the mobile device executes the application (e.g., an inventory management application) and the application includes a user interface. The user interface can have any number of pages, menus, etc. and presents the inventory management tasks for the user. Additionally, or alternatively, the mobile device can present the inventory management tasks via a web browser.

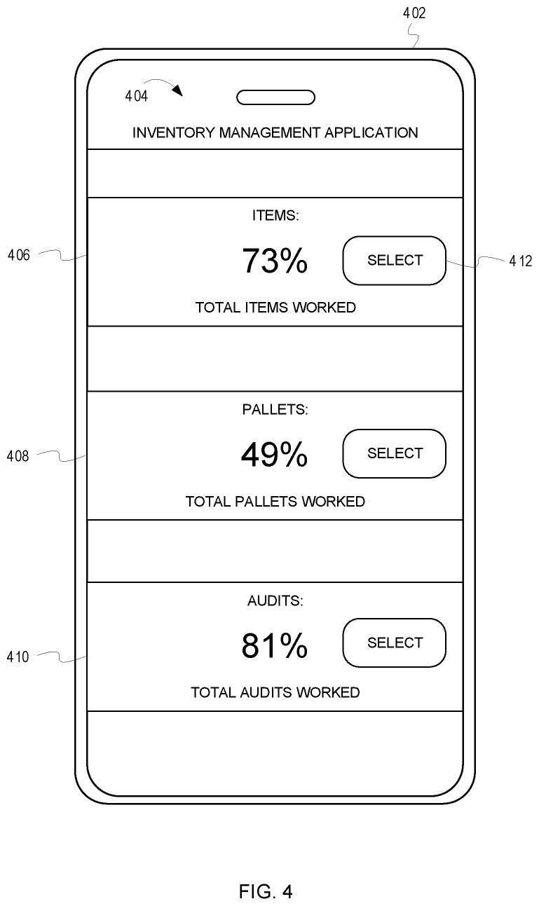

While the discussion of FIG. 3 describes example operations of a system for inventory management, the discussion of FIG. 4 provides additional information regarding an alternate user interface of an inventory management application.

FIG. 4 depicts a mobile device 402 executing an inventory management application with an alternate user interface 404, according to some embodiments. The user interface 404 includes a number of inventory task management categories. Specifically, in the example provided in FIG. 4, the user interface 404 includes three inventory task management categories: 1) an items category 406, 2) a pallets category 408, and 3) an audits category 410. Each of the inventory task management categories includes a selection button 412. Selection of the selection button 412 causes presentation, by the inventory management application, of more information related to the associated inventory task management category. In one embodiment, the user interface 404 depicted in FIG. 4 can be a higher level user interface than that depicted in FIG. 1. For example, in such embodiments, selection of one or more items in the user interface 404 prompts the inventory management application to present more detailed information, such as the user interface depicted in FIG. 1. Specifically, in this example, selection of the selection button 412 associated with the item category 406 would cause presentation of the user interface depicted in FIG. 1 in which an employee can see additional information about inventory management task that fall within the items category 406. Similarly, selection of the selection button 412 for the pallets category 408 would cause presentation of additional information about inventory management tasks that fall within the pallets category 408 and selection of the selection button 412 for the audit category 410 would cause presentation of additional information about inventory management tasks that fall within the audits category 410. Additionally, in some embodiments, each of the inventory management task categories can include a progress indicator for the category. For example, user interface 404 includes an indication that 73% of the items category 406 inventory management tasks have been completed.

As with the items category 406 inventory management tasks described with respect to FIG. 1, both the pallets category 408 and audits category 410 can include any desired tasks. For example, the pallets category 408 can include drop list tasks, work pallet exception tasks, and expiration dates tasks and the audits category 410 can include complete item audits tasks and pre-counting for audits tasks. The tasks provided above, and explained in more detail below, are but example tasks and any suitable tasks can be used with the inventory management system.

Drop List Tasks

A drop list task occurs when an employee requests that a pallet be moved from a storage location (e.g., a non-accessible location such as a rack or a storage facility) to a stocking location (e.g., a location that is accessible to employees to retrieve items from the pallet, such as the floor of the stockroom). In one embodiment, a first employee may need to replenish a product on the salesfloor from the stockroom. However, if the product is located on a pallet that is not easily accessible, the first employee can initiate a drop list task for the pallet via his or her mobile device 402. The inventory management application for a second employee (e.g., a forklift operator) may update to include the drop list task for the pallet. The drop list task for the pallet would add an inventory management task to the second employee's list to retrieve the requested pallet and place it in an accessible location.

Work Pallet Exception Tasks

A work pallet exception task occurs when a location for a pallet needs to be verified. For example, the location for a pallet could be suspected to be inaccurate. In one embodiment, work pallet exception tasks are automatically generated. For example, work pallet exception tasks can be generated based on an algorithm that detects potential errors in pallet locations. The algorithm can consider any relevant information, such as time periods (e.g., how long has a pallet been in its current location), dates (e.g., the date upon which the current location for the pallet was entered), the current location of the pallet, other items at or near the current location of the pallet, etc. As one example, if the algorithm determines that the pallet has been at its current location for three months and that, based on the other items at or near the current location of the pallet, there wouldn't be enough room for the pallet at the current location, the algorithm can generate a work pallet exception task for the pallet. An employee can complete the work pallet exception task by verifying that the pallet, and any other items at or near the location of the pallet, are indeed correctly located. If the location for the pallet is correct, the employee can confirm this by providing such an indication, scanning the pallet, capturing an image of the pallet, etc. If the pallet is not at the location, the employee can indicate so and, in some embodiments, provide a correct location for the pallet.

Expiration Dates Tasks

An expiration date task occurs when a pallet includes products that have temporal restrictions that are approaching. Temporal restrictions could apply, for example, to holiday products, seasonal products (e.g., snow blowers, lawn mowers, summer clothes, mulch, etc.), grocery products, etc. As one example, if a pallet includes snow shovels and the end of the winter season is approaching, an expiration date task can be created for the pallet. The expiration dates task instructs an employee to move the contents of the pallet (i.e., the snow shovels) to the salesfloor and/or bring the pallet to an accessible location so that the contents of the pallet can be moved to the salesfloor.

Complete Item Audits Tasks

Complete item audits tasks occur when an audit is to be conducted. The complete item audits tasks inform employees which products need to be audited. The employees can conduct the audit as a hand count, by scanning products, etc. In some embodiments, when an audit of an entire retail facility is to be conducted, a complete items audit task is generated for each of the products in the retail facility. Alternatively, complete audit items tasks can be generated only for specific products, such as high value products, high shrink products, categories of products, etc. In such embodiments, the tasks can be generated algorithmically based on any suitable requirements, preferences, data, etc. Once an employee has completed the complete item audits task for a product, in some embodiments, an indication of the completion is provided to a second employee, such as a manager. The second employee can confirm, verify, signoff on, etc. the complete item audits task.

Pre-Counting for Audits Tasks

A pre-counting for audits task occurs when a preparation for an audit is to occur. For example, the pre-counting for audits tasks can instruct employees to provide a count for products. The count for products can be written on, for example, paper and attached to the pallets and/or input into the system for a pre-count.

In addition to inventory management tasks, the inventory management application can include a number of tools. The tools allow employees to request action, view information, input information, etc. regarding inventory management. The tools can include a drop pallet tool, place pallet in reserve tool, a manage pallets tool, a manage locations tool, a donate tool, and a throw away tool. Though only a small number of tools are listed above, and described below, any suitable tools that are desired can be incorporated into the inventory management application.

Drop Pallet Tool

Employees can use the drop pallet tool to request that a pallet be moved to an accessible location. In some embodiments, utilization of the drop pallet tool creates a drop lists task for a pallet.

Place Pallet in Reserve Tool

Employees can use the place pallet in reserve tool to request that a pallet be replaced after products are removed from the pallet. For example, if an employee has previously requested that a pallet be dropped, he or she can request that the pallet be placed in reserve after he or she is done accessing the pallet (e.g., removing products from the pallet, conducting an audit, etc.). In some embodiments, utilization of the place pallet in reserve tool creates a reserve pallet task in which an employee is instructed to place the pallet in reserve (e.g., in a storage area, such as a different location or on a shelf).

Manage Pallets Tool

Employees can use the manage pallets tool to retrieve information about a pallet. For example, the employee can input a pallet identifier via the inventory management application. The inventory management application provides the employee with information about the pallet, such as its contents, location, restrictions, locations for the pallet's contents on the salesfloor, temporal information for the pallet and/or its contents, etc.

Manage Locations Tool

Employees can use the manage locations tool to explore locations within the retail facility. For example, an employee can select a location and view what products, pallets, product display units, etc. are at the location. Additionally, in some embodiments, employees can use the manage locations tool to update locations within the inventory management system. For example, an employee, such as a manager, can use the manage locations tool to update the location of a product or pallet in the inventory management system.

Donate Tool

Employees can use the donate tool to request that products be donated. For example, a grocery product may be nearing its sell by date or a returned product may not be acceptable for sale. In such instances, the employee can request that the product be donated.

Throw Away Tool

Employees can use the throw away tool to request that products be thrown away or otherwise disposed of. For example, if a grocery product is no longer suitable for sale (e.g., its sell by date has passed), the employee can request that the grocery product be thrown away or otherwise disposed of.

While the discussion of FIG. 4 describes additional information regarding an alternate user interface of an inventory management application, the discussion of FIG. 5 provides additional detail regarding mobile devices and applications configured to be executed on mobile devices.

FIG. 5 is a block diagram of a mobile device 500, according to some embodiments. The mobile device 500 may be used for implementing any of the components, systems, functionality, apparatuses, processes, or devices of the system 200 of FIG. 2, and/or other above or below mentioned systems or devices, or parts of such functionality, systems, apparatuses, processes, or devices. The systems, devices, processes, methods, techniques, functionality, services, servers, sources and the like described herein may be utilized, implemented and/or run on many different types of devices and/or systems.

By way of example, the mobile device 500 may comprise a control circuit or processor 512, memory 514, and one or more communication links, paths, buses or the like 518. Some embodiments may include one or more user interfaces 516, and/or one or more internal and/or external power sources or supplies 540. The control circuit 512 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor 512 can be part of control circuitry and/or a control system 510, which may be implemented through one or more processors with access to one or more memory 514 that can store commands, instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 500 may be used to implement one or more of the above or below, or parts of, components, circuits, systems, processes and the like.

In one embodiment, the memory 514 stores data and executable code, such as an operating system 536 and an application 538. The application 538 is configured to be executed by the mobile device 500 (e.g., by the processor 512). The application 538 can be a dedicated application (e.g., an application dedicated to inventory management tasks) and/or a general purpose application (e.g., a web browser, a retail application etc.). Additionally, though only a single instance of the application 538 is depicted in FIG. 5, such is not required and the single instance of the application 538 is shown in an effort not to obfuscate the figures. Accordingly, the application 538 is representative of all types of applications resident on the mobile device (e.g., software preinstalled by the manufacturer of the mobile device, software installed by an end user, etc.). In one embodiment, the application 538 operates in concert with the operating system 536 when executed by the processor 512 to cause actions to be performed by the mobile device 500. For example, with respect to the disclosure contained herein, execution of the application 538 by the processor 512 causes the mobile device to perform actions consistent with the inventory management tasks and tool described herein.

The user interface 516 can allow a user to interact with the system 500 and receive information through the system. In some instances, the user interface 516 includes a display device 522 and/or one or more user input device 524, such as buttons, touch screen, track ball, keyboard, mouse, etc., which can be part of or wired or wirelessly coupled with the mobile device 500. Typically, the mobile device 500 further includes one or more communication interfaces, ports, transceivers 520 and the like allowing the mobile device 500 to communicate over a communication bus, a distributed computer and/or communication network (e.g., a local area network (LAN), wide area network (WAN) such as the Internet, etc.), communication link 518, other networks or communication channels with other devices and/or other such communications or combination of two or more of such communication methods. Further the transceiver 520 can be configured for wired, wireless, optical, fiber optical cable, satellite, or other such communication configurations or combinations of two or more of such communications. Some embodiments include one or more input/output (I/O) ports 534 that allow one or more devices to couple with the mobile device 500. The I/O ports can be substantially any relevant port or combinations of ports, such as but not limited to USB, Ethernet, or other such ports. The I/O interface 534 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the mobile device 500 may include one or more sensors 526 to provide information to the system and/or sensor information that is communicated to another component, such as the central control system, a delivery vehicle, etc. The sensors 526 can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The mobile device 500 comprises an example of a control and/or processor-based system with the control circuit 512. Again, the control circuit 512 can be implemented through one or more processors, controllers, central processing units, logic, software and the like. Further, in some implementations the control circuit 512 may provide multiprocessor functionality.

The memory 514, which can be accessed by the control circuit 512, typically includes one or more processor-readable and/or computer-readable media accessed by at least the control circuit 512, and can include volatile and/or nonvolatile media, such as RAM, ROM, EEPROM, flash memory and/or other memory technology. Further, the memory 514 is shown as internal to the control system 6510; however, the memory 514 can be internal, external or a combination of internal and external memory. Similarly, some or all of the memory 514 can be internal, external or a combination of internal and external memory of the control circuit 512. The external memory can be substantially any relevant memory such as, but not limited to, solid-state storage devices (SSDs) or drives, hard disk drives (HDDs), one or more of universal serial bus (USB) stick or drive, flash memory secure digital (SD) card, other memory cards, and other such memory or combinations of two or more of such memory, and some or all of the memory may be distributed at multiple locations over a computer network. The memory 514 can store code, software, executables, scripts, data, content, lists, programming, programs, log or history data, user information, customer information, product information, and the like. While FIG. 5 illustrates the various components being coupled together via a bus, it is understood that the various components may actually be coupled to the control circuit and/or one or more other components directly.

Further, it is noted that while FIG. 5 illustrates a generic architecture of the mobile device 500 in some embodiments, this similar architecture can apply to at least the control circuit 202 and the networked server system 212. For example, the control circuit 202 could equate to the control circuit 512 of FIG. 5, and it is understood that the control circuit 202 would likewise be coupled to or have access to one or more of memories, power, user interfaces, I/Os, transceivers, sensors, etc. Similarly, in some embodiments, the networked server system 212 could be embodied to include at least one control circuit, memories, power, user interfaces, I/Os, transceivers, sensors, etc.

In some embodiments, an inventory management system for a retailer comprises a networked server system comprising a plurality of computer hardware components and memory structures, the networked server system configured to function as a public cloud and maintain inventory management tasks, a control circuit, wherein the control circuit is communicatively coupled to the networked server system, and wherein the control circuit is owned and operated by the retailer independently of the public cloud owned and operated by a third party, the control circuit configured to receive, from a plurality of in-store systems, inventory management information, wherein each of the plurality of in-store systems is associated with a different retail facility of the retailer, generate, based on the inventory management information, the inventory management tasks, transmit, to the networked server system, the inventory management tasks, receive, from a mobile device, user credentials, and authenticate, based on the user credentials, the mobile device, wherein the authentication allows the mobile device to access the networked server system, and the mobile device, wherein the mobile device is maintained by an employee of the retailer, wherein the mobile device is communicatively coupled to the networked server system, and wherein the mobile device is configured to receive, at the mobile device, the user credentials, transmit, to the control circuit, the user credentials, access the networked server system, and present, via a display device, indications of the inventory management tasks.

In some embodiments, an apparatus and a corresponding method performed by the apparatus comprises maintaining, in a networked server system, inventory management tasks, wherein the networked server system comprises a plurality of computer hardware components and memory structures, the networked server system configured to function as a public cloud, receiving, at a control circuit from a plurality of in-store systems, inventory management information, wherein each of the plurality of in-store systems is associated with a different retail facility of the retailer, wherein the control circuit is owned and operated by the retailer independently of the public cloud owned and operated by a third party, generating, by the control circuit based on the inventory management information, the inventory management tasks, transmitting, by the control circuit to the networked server system, the inventory management tasks, receiving, via a user input device of a mobile device, user credentials, wherein the mobile device is maintained by an employee of the retailer, transmitting, by the mobile device to the control circuit, the user credentials, receiving, by the control circuit from the mobile device, the user credentials, authenticating, by the control circuit based on the user credentials, the mobile device, wherein the authentication allows the mobile device to access the networks server system, accessing, by the mobile device, the networked server system, and presenting, via a display device of the mobile device, indications of the inventory management tasks.

In some embodiments, an inventory management system for a retailer comprises a control circuit, wherein the control circuit is communicatively coupled to a networked server system, wherein the networked server system comprises a plurality of computer hardware components and memory structures and the networked server system configured to function as a public cloud, and wherein the control circuit is owned and operated by the retailer independently of the public cloud owned and operated by a third party, the control circuit configured to receive, from a plurality of in-store systems, inventory management information, wherein each of the plurality of in-store systems is associated with a different retail facility of the retailer, generate, based on the inventory management information, the inventory management tasks, transmit, to the networked server system, the inventory management tasks to be maintained by the networked server system, receive, from a mobile device, user credentials, and authenticate, based on the user credentials, the mobile device, wherein the authentication allows the mobile device to access the networked server system, and an application configured to be executed on the mobile device, wherein the mobile device is maintained by an employee of the retailer, wherein the mobile device is communicatively coupled to the networked server system, and wherein the application when executed on the mobile device is configured to receive, from the mobile device, the user credentials, cause transmission, to the control circuit, the user credentials, access the networked server system, and cause presentation, via a display device of the mobile device, indications of the inventory management tasks.

In some embodiments, an apparatus and a corresponding method performed by the apparatus comprises maintaining, in a networked server system, inventory management tasks, wherein the networked server system comprises a plurality of computer hardware components and memory structures, the networked server system configured to function as a public cloud, receiving, at a control circuit from a plurality of in-store systems, inventory management information, wherein each of the plurality of in-store systems is associated with a different retail facility of the retailer, wherein the control circuit is owned and operated by the retailer independently of the public cloud owned and operated by a third party, generating, by the control circuit based on the inventory management information, the inventory management tasks, transmitting, by the control circuit to the networked server system, the inventory management tasks, receiving, by an application configured to be executed on a mobile device via a user input device of a mobile device, user credentials, wherein the mobile device is maintained by an employee of the retailer, causing transmission, by the application configured to be executed on the mobile device to the control circuit, the user credentials, receiving, by the control circuit from the mobile device, the user credentials, authenticating, by the control circuit based on the user credentials, the mobile device, wherein the authentication allows the mobile device to access the networks server system, accessing, by the application configured to be executed on the mobile device, the networked server system, and causing presentation, by the application configured to be executed on the mobile deice via a display device of the mobile device, indications of the inventory management tasks.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An inventory management system for a retailer, the inventory management system comprising:
a control circuit, wherein the control circuit is communicatively coupled to a networked server system, wherein the networked server system comprises a plurality of computer hardware components and memory structures and the networked server system configured to function as a public cloud, and wherein the control circuit is owned and operated by the retailer independently of the public cloud owned and operated by a third party, the control circuit configured to:
receive, from a plurality of in-store systems, inventory management information, wherein each of the plurality of in-store systems is associated with a different retail facility of the retailer;
generate, based on the inventory management information, inventory management tasks;
transmit, to the networked server system, the inventory management tasks to be maintained by the networked server system;
receive, from a mobile device, user credentials; and
authenticate, based on the user credentials, the mobile device, wherein the authentication allows the mobile device to access the networked server system; and
an application configured to be executed on the mobile device, wherein the mobile device is maintained by an employee of the retailer, wherein the mobile device is communicatively coupled to the networked server system, and wherein the application when executed on the mobile device is configured to:
receive, from the mobile device, the user credentials;
cause transmission, to the control circuit, of the user credentials;
access the networked server system; and
cause presentation, via a display device of the mobile device, indications of the inventory management tasks.

2. The inventory management system of claim 1, wherein the in-store systems include one or more of an inventory database, a location database, and a transaction database.

3. The inventory management system of claim 1, wherein the application when executed on the mobile device is further configured to:
receive, by the application via a user input device of the mobile device, user input indicating that one of the inventory management tasks has been completed; and
cause transmission, to the networked server system by the mobile device, an indication that the one of the inventory management tasks has been completed.

4. The inventory management system of claim 3, wherein the indication that the one of the inventory management tasks has been completed includes an indication of an employee that completed the one of the inventory management tasks.

5. The inventory management system of claim 1, further comprising:
the mobile device, wherein the mobile device is maintained by the employee of the retailer in that the mobile device is owned by the employee.

6. The inventory management system of claim 1, wherein the inventory management tasks include one or more of no sales, nil picks, no floor locations, cancelled items, negative on-hands, price overrides, drop lists, work pallet exceptions, expiration dates, complete item audits, and pre-counting for audits.

7. The inventory management system of claim 1, wherein the control circuit generates the inventory management tasks based on machine learning.

8. The inventory management system of claim 1, wherein the application when executing on the mobile device is further configured to:
cause capture, by the application via an image capture device associated with the mobile device, a product identifier associated with a product; and
retrieve, from the networked server system based on the product identifier, product information for the product.

9. The inventory management system of claim 8, wherein the product information includes one or more of cost information for the product, inventory information for the product, and location information for the product.

10. The inventory management system of claim 1, wherein the user credentials are based on a single sign on system.

11. The inventory management system of claim 1, further comprising the networked server system.

12. A method for inventory management for a retailer, the method comprising:
maintaining, in a networked server system, inventory management tasks, wherein the networked server system comprises a plurality of computer hardware components and memory structures, the networked server system configured to function as a public cloud;
receiving, at a control circuit from a plurality of in-store systems, inventory management information, wherein each of the plurality of in-store systems is associated with a different retail facility of the retailer, wherein the control circuit is owned and operated by the retailer independently of the public cloud owned and operated by a third party;
generating, by the control circuit based on the inventory management information, the inventory management tasks;
transmitting, by the control circuit to the networked server system, the inventory management tasks;
receiving, by an application configured to be executed on a mobile device via a user input device of the mobile device, user credentials, wherein the mobile device is maintained by an employee of the retailer;
causing transmission, by the application configured to be executed on the mobile device to the control circuit, the user credentials;
receiving, by the control circuit from the mobile device, the user credentials;
authenticating, by the control circuit based on the user credentials, the mobile device, wherein the authentication allows the mobile device to access the networked server system;
accessing, by the application configured to be executed on the mobile device, the networked server system; and
causing presentation, by the application configured to be executed on the mobile device via a display device of the mobile device, indications of the inventory management tasks.

13. The method of claim 12, wherein the in-store systems include one or more of an inventory database, a location database, and a transaction database.

14. The method of claim 12, further comprising:
receiving, by the application executing on the mobile device via the user input device of the mobile device, user input indicating that one of the inventory management tasks has been completed; and
causing transmission, by application executing on the mobile device to the networked server system, an indication that the one of the inventory management tasks has been completed.

15. The method of claim 14, wherein the indication that the one of the inventory management tasks has been completed includes an indication of an employee that completed the one of the inventory management tasks.

16. The method of claim 12, wherein the mobile device is maintained by the employee of the retailer in that the mobile device is owned by the employee.

17. The method of claim 12, wherein the inventory management tasks include one or more of no sales, nil picks, no floor locations, cancelled items, negative on-hands, price overrides, drop lists, work pallet exceptions, expiration dates, complete item audits, and pre-counting for audits.

18. The method of claim 12, wherein the control circuit generates the inventory management tasks based on machine learning.

19. The method of claim 12, further comprising:
causing capture, by the application executing on the mobile device via an image capture device associated with the mobile device, a product identifier associated with a product; and
retrieving, by the application executing on the mobile device from the networked server system based on the product identifier, product information for the product.

20. The method of claim 19, wherein the product information includes one or more of cost information for the product, inventory information for the product, and location information for the product.

21. The method of claim 12, wherein the user credentials are based on a single sign on system.
